(19) United States
(12) Patent Application Publication
(10) Pub. No.: US 2010/0000386 A1
(43) Pub. Date: Jan. 7, 2010

(54) MANUALLY OPERATED DRILLING OR MILLING APPARATUS WITH A SUCTION DEVICE

(76) Inventor: Josef Dagn, Kossen (AU)

Correspondence Address: KLEIN, O'NEILL & SINGH, LLP, 43 CORPORATE PARK, SUITE 204, IRVINE, CA, 92606, US

(21) Appl. No.: 12/301,454

(22) PCT Filed: May 15, 2007
(86) PCT No.: PCT/EP07/04327

§ 371 Date: Jun. 10, 2009

(30) Foreign Application Priority Data
May 19, 2006 (DE) 202006008068.6

(51) Int. Cl. B23Q 11/00; B25D 17/14

(52) U.S. Cl. 83/100; 173/75; 409/137; 408/67

(57) ABSTRACT

The invention relates to a manual drilling or milling apparatus with a suction device, especially for cutting windscreens of motor vehicles, comprising a housing fixed at the drilling or milling head in which a radial impeller is rotatably supported which can be driven by the drilling or milling head, a suction pipe which is telescopically adjustable at the housing and through which the drill or milling cutter extends, and a catchment tank connected to the housing.

### CROSS-REFERENCE TO RELATED APPLICATION(S)

This is a national phase application of PCT No. PCT/EP2007/004327, filed May 15, 2007, which claims priority to German Utility Model DE 20 2006 008 068.6, filed May 19, 2006, the contents of which are expressly incorporated herein by reference.

### BACKGROUND

The invention relates to a manually operated drilling or milling apparatus having a suction device, for example a battery-driven drill or milling cutter.

In emergence operations by the fire brigade, it is important for the rescue and treatment of persons, for example in a car accident, to be able to cut a large opening in the windscreen or rear windscreen as quickly as possible to reach the persons to be treated when the doors are blocked. Here, incidental glass dust, which can cause injury, is to be avoided.

### SUMMARY

It is the object of the invention to provide a convenient drilling or milling apparatus for emergency operations, by means of which an opening can be cut in a glass surface without glass dust hindering the rescue work.

According to the invention, this is achieved by an apparatus according to claim 1. By means of the housing attached to the drilling or milling apparatus with a radial impeller driven by the drill or milling cutter, effective suction of the glass dust incidental to the cutting of an opening in a glass panel is achieved, wherein a compact and convenient configuration of the apparatus is attained.

### BRIEF DESCRIPTION OF THE FIGURES

An exemplary embodiment of the invention is explained in more detail below, with reference to the drawing, in which:

FIG. 1 shows a plan view and a side view of a battery driven drilling apparatus or manually operated milling apparatus with the suction device,

FIG. 2 shows a plan view of the suction device,

FIG. 3 shows a side view of the suction device,

FIG. 4 shows a partial section along the line G-G in FIG. 2,

FIG. 5 shows an exploded view of the component parts of the suction device,

FIG. 6 shows the mode of operation of the apparatus, and

FIG. 7 shows a perspective view of a drill or milling cutter.

### DETAILED DESCRIPTION

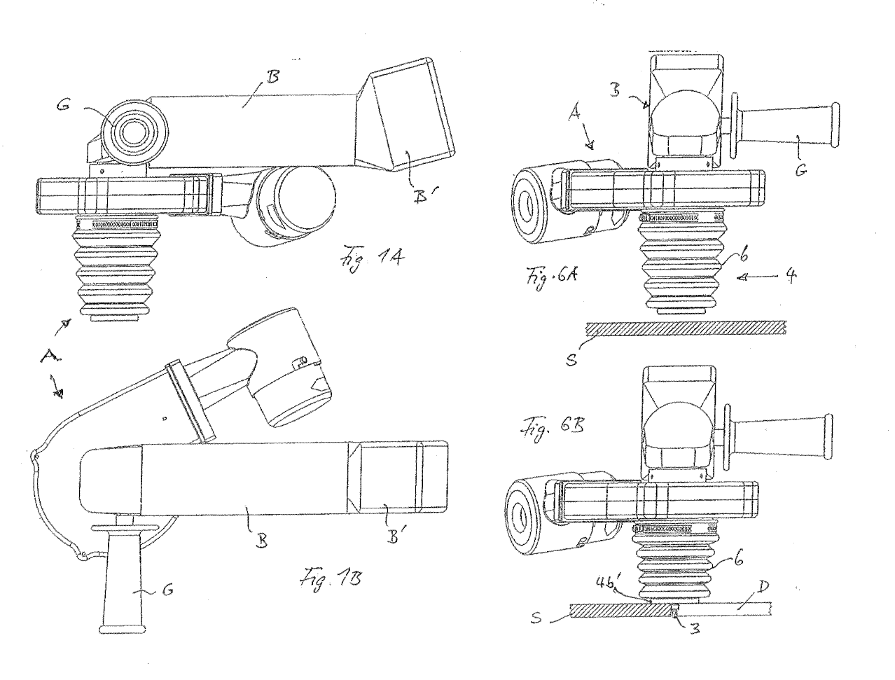

FIGS. 1A and 1B show a drilling or milling apparatus B which is driven by a battery B′ and to which a suction device A is attached. A handle of the apparatus is termed G.

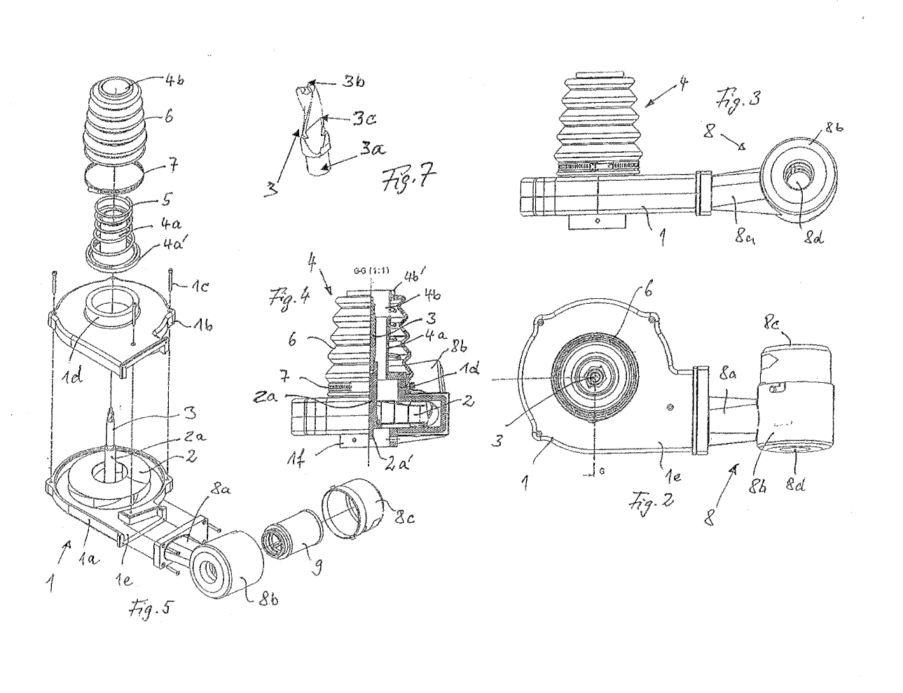

In the embodiment shown in FIGS. 2 to 5, an approximately disc-shaped housing 1 consists of two housing parts 1a and 1b connected to each other by screws 1c. A radial impeller 2 is rotatably mounted in the housing 1, as shown in FIGS. 4 and 5. A drill or milling cutter 3 extends through the central opening of the radial impeller 2. An upper tubular neck 1d is formed onto the upper housing half 1b in FIG. 5 concentrically to the milling cutter 3, at which upper tubular neck 1d a telescopically adjustable suction pipe 4 is fixed.

The suction pipe 4 has an inner pipe section 4a with a flange 4a′ on one side supported by the upper tubular neck 1d of the housing, on which flange a helical spring 5 is supported whose upper end abuts at the end of rubber bellows 6, whose upper end is joined to an outer pipe section 4b having a collar 4b′ to which the rubber bellows 6 are fixed. The lower end of the rubber bellows 6 is fixed, for example by a hose fitting 7, to the upper tubular neck 1d of the housing.

In the ready position in FIG. 6A, the deployed suction pipe 4 covers the tip of the milling cutter 3. On applying and pressing the apparatus onto a glass panel S by means of the collar 4b′, the outer pipe section 4b in FIG. 4 is displaced over the inner pipe section 4a against the force of the spring 5, so that the tip of the milling cutter 3 is exposed and can penetrate the glass panel S by means of an active cutting part 3b (FIG. 7) of the milling cutter, as FIG. 6B shows, wherein D represents an opening cut in the glass panel by the milling cutter 3.

FIG. 7 shows a milling cutter 3 soldered into a threaded part 3a. The tip of the milling cutter is provided with the active cutting part 3b which penetrates the glass surface without slipping by means of lightly pressing the apparatus on the glass surface. The open coils 3c of the active cutting part transport the glass splinters into the inner pipe section 4a and from there they reach the catchment tank 8 via the impeller 2.

As FIG. 4 shows, the lower side of the lower housing part 1a or the lower side of the radial impeller 2 is closed, so that the glass dust which occurs during milling is drawn off through the suction pipe 4 by means of the radial impeller 2. At the circumference of the disc-shaped housing 1, a radially projecting neck 1e is formed at which a catchment tank 8 is flange-mounted, which is manufactured from plastic material in the embodiment shown and has a passage section 8a connected to the housing neck 1e, on whose opposite side an approximately tubular housing 8b is formed on, which is open on one side and covered by a preferably transparent cap 8c, which can be joined, for example by means of a bayonet fitting, to the tubular housing 8b. In the catchment tank 8, a tubular filter 9 is arranged such that the air introduced from the radial impeller 2 into the catchment tank flows around the filter 9 from outside, so that glass dust settles on the outer circumference, wherein the filling degree of the catchment tank is visible through the transparent cap 8c. In FIG. 2, the upper front end of the filter 9 is formed closed, while the lower front end is open and communicates with an outlet opening 8d in the housing 8b, through which the air freed from glass dust is discharged.

To protect the radial impeller 2 from the sharp-edged glass dust, it can be provided with a ceramic coating. Similarly, the housing 1 is manufactured from correspondingly robust cast aluminium.

On the lower side of the lower housing part 1a, a lower tubular neck 1f is formed which can be provided with radial tapped bores for fixing the suction device A on the drilling or milling head of the apparatus B.

In the embodiment shown in FIG. 4, the milling cutter 3 is joined to the radial impeller 2 such that the milling cutter 3 is screwed into a central boss 2a of the impeller 2 by means of the threaded part 3a. The boss 2a forms a unit with the impeller 2. On the lower side of the impeller in FIG. 4, a pin 2a′ of the boss 2a projects and engages with the milling or drilling head of the apparatus B. In the embodiment according to FIG. 4, the milling cutter 3 is releasably joined to the impeller 2, so that it can be replaced when it becomes worn. The suction device A is fixedly connected to the apparatus B by means of the lower tubular neck 1f of the housing 1.

Instead of the milling cutter 3 inserted in a central boss 2a of the impeller 2, an embodiment can also be provided in which the milling cutter 3 is inserted directly at the drilling or milling head of the manual apparatus B and the suction device A is attached to this, wherein the impeller 2 is driven, for example, by friction locking with the drilling head or the milling cutter 3. In such an embodiment, the milling cutter 3 can be inserted directly at the manual apparatus B and the suction device A can then be attached to the manual apparatus.

What is claimed is:

1. A manual drilling or milling apparatus with a suction device for cutting comprising:
a housing attached to a drilling or milling head having a radial impeller rotatably supported therein, the radial impeller being drivable by the drilling or milling head,
a suction pipe telescopically adjustable at the housing and through which a drill or milling cutter extends, and
a catchment tank connected to the housing.

2. The apparatus according to claim 1, wherein the housing is connected to the catchment tank via a radially projecting passage neck, and wherein the catchment tank houses a tubular filter.

3. The apparatus according to claim 2, wherein the catchment tank comprises a section tubular housing in communication with the housing via a passage section and is coverable by a covering cap.

4. The apparatus according to claim 3, wherein the covering cap is transparent.

5. The apparatus according to claim 1, wherein the housing is connectable on one side to the drilling or milling apparatus by a lower tubular neck, and on the opposite side to the suction pipe by an upper tubular neck.

6. The apparatus according to claim 1, wherein the suction pipe comprises an inner pipe section and an outer pipe section that overlap one another telescopically; and
wherein the inner and outer pipe sections are surrounded by rubber bellows.

7. The apparatus according to claim 1, wherein the radial impeller further comprises a central boss for engaging with the milling cutter, the radial impeller being drivable by the drilling or milling apparatus via a pin.

8. A suction device for a manually operated drilling or milling apparatus comprising:
a housing having a radial impeller and a drilling or milling head rotatably supported therein, the radial impeller being drivable by the drilling or milling head;
a suction pipe covering the drilling or milling head, said suction pipe being telescopically movable to expose the drilling or milling head for cutting, and
a catchment tank connected to the housing.

9. The apparatus according to claim 1, wherein the catchment tank is formed from a plastic material.

10. The apparatus according to claim 1, wherein the housing is disc-shaped.

11. The suction device of claim 8, wherein the radial impeller is structured to produce a vacuum when the drilling or milling head is rotated.

12. The suction device of claim 8, wherein the catchment tank is formed from a plastic material.

13. The suction device of claim 8, wherein the housing is disc-shaped.

14. The suction device of claim 11, wherein the catchment tank comprises a tubular housing, and wherein the tubular housing is in communication with the housing via a passage section, and is coverable by a covering cap.

15. The suction device of claim 14, wherein the covering cap is transparent.

16. The suction device of claim 8, wherein the housing is connectable on one side to the drilling or milling apparatus by a lower tubular neck, and on the opposite side to the suction pipe by an upper tubular neck.

17. The suction device of claim 8, wherein the suction pipe comprises an inner pipe section in communication with the housing and an outer pipe section; and
wherein the inner and outer pipe sections are surrounded by rubber bellows.

18. A manual drilling or milling apparatus with a suction device for cutting comprising:
a housing defining an interior space and having a radial impeller mounted therein,
a drilling or milling tool comprising a shaft and a cutting head, said cutting head projecting outside the housing,
a suction pipe surrounding the cutting head of the drilling or milling tool, said suction pipe being collapsible to expose the cutting head.

19. The manual drilling or milling apparatus of claim 18, further comprising a catchment tank for catching debris suctioned by the radial impeller.

20. The manual drilling or milling apparatus of claim 19, further comprising a filter positioned inside the catchment tank.
